(19) United States
(12) Patent Application Publication
(10) Pub. No.: US 2025/0124616 A1
(43) Pub. Date: Apr. 17, 2025

(54) OBJECT DETECTION METHOD AND SYSTEM

(71) Applicant: GE Precision Healthcare LLC, Waukesha, WI (US)

(72) Inventors: Xiaodong Lu, Beijing (CN); Sinan Piao, Beijing (CN); Yingqing Lyu, Beijing (CN)

(21) Appl. No.: 18/919,046

(22) Filed: Oct. 17, 2024

(30) Foreign Application Priority Data
Oct. 17, 2023 (CN) 202311346624.4

(51) Int. Cl. G06T 11/00; G06T 7/62; G06T 7/70

(52) U.S. Cl. CPC G06T 11/003; G06T 7/62; G06T 7/70; G06T 2211/40

(57) ABSTRACT

The present invention relates to an object detection method and system for an imaging device. At least a part of an object is located in a subject under examination. The object detection method includes: obtaining volumetric image data generated by scanning a region of interest of the subject by the imaging device; converting the volumetric image data into feature projection images, the feature projection images including three orthogonal plane feature projection images; detecting coordinates of the object in each of the three orthogonal plane feature projection images to obtain corresponding projection coordinates of the object in respective coordinate systems of the three orthogonal plane feature projection images; and obtaining global coordinates of the object in a global coordinate system of the imaging device on the basis of the projection coordinates of the object.

### CROSS-REFERENCE TO RELATED APPLICATIONS

This application claims priority to Chinese Application No. 202311346624.4, filed on Oct. 17, 2023, the disclosure of which is incorporated herein by reference in its entirety.

### TECHNICAL FIELD

The present invention relates to the field of computer imaging, and relates in particular to an object detection method and system for an imaging device. The present invention further relates to a computer-readable medium storing instructions for executing the object detection method, and an imaging device including the object detection system.

### BACKGROUND

In the field of imaging, the technology for detecting objects in slice images generated by imaging devices has a wide range of applications. For example, a puncture needle within the body of a patient can be identified from a medical image. However, one challenge currently faced by such technology is that object detection requires a relatively long time, because conventional object detection technology requires that object detection be performed on all generated slice images in sequence. Moreover, as the number of images increases, the time overhead for object detection substantially increases proportionally. The number of images may be proportional to, for example, the width and/or accuracy of a scan. The wider the scan width, the larger the image coverage, and the greater the number of images. For example, under default settings, generally, 16 images can be generated at a scan width of 10 mm (millimeters), 32 images can be generated at a scan width of 20 mm, and 64 images can be generated at a scan width of 40 mm. The higher the scan accuracy, the more images will be generated at the same scan width. For example, using the 40 mm scan width as an example, 32 images can be generated at a scan accuracy of 1.25 mm, while 64 images can be generated if the scan accuracy is increased to 0.625 mm. In specific situations, for example, an object (such as a puncture needle) is bent, tilted, and/or needs to enter the human body at a greater angle relative to the scan plane probably for the purpose of avoiding an obstacle (such as bones, blood vessels, and so on), such phenomena may also lead to an increase in the number of images. For example, a scan width of 10 mm may require 24 images to be generated, and/or a larger scan width may be required as a result, thereby increasing the number of images in a single scan. In addition, the resolution of the image itself also affects the time overhead for object detection. The higher the image resolution, the more pixels contained in the image, and the longer the time required for detection. For example, the time required by object detection for a 512×512 dot matrix image would be four times the time required by object detection for a 256×256 dot matrix image.

As the time overhead for object detection increases, the tap cycle time of the imaging device increases, thereby leading to a less efficient operation of the imaging device, while increasing the radiation to which the subject under examination and/or the operator of the imaging system is exposed. In addition, this issue also increases the discomfort of living subjects and affects their recovery.

Therefore, there is a need in the art for an improved object detection method and system to reduce the time overhead for object detection. In addition, the time overhead required by object detection is substantially unchanged if the image contains an increased volume or if slice image data increases while the volume remains the same.

### SUMMARY

According to an aspect of the present invention, an object detection method is provided. At least a part of the object may be located in a subject under examination. The object detection method may include obtaining volumetric image data generated by scanning a region of interest of the subject by the imaging device, converting the volumetric image data into feature projection images, where the feature projection images including three orthogonal plane feature projection images, detecting coordinates of the object in each of the three orthogonal plane feature projection images to obtain corresponding projection coordinates of the object in respective coordinate systems of the three orthogonal plane feature projection images, and obtaining global coordinates of the object in a global coordinate system of the imaging device on the basis of the projection coordinates of the object.

According to another aspect of the present invention, an object detection system is provided. At least a part of the object may be located in a subject under examination. The object detection system may comprise a memory, the memory being configured to store volumetric image data generated by scanning a region of interest of the subject by an imaging device. The object detection system may further include a processor configured to perform the following: obtaining the volumetric image data from the memory, converting the volumetric image data into feature projection images, where the feature projection images including three orthogonal plane feature projection images, detecting coordinates of the object in each of the three orthogonal plane feature projection images to obtain corresponding projection coordinates of the object in respective coordinate systems of the three orthogonal plane feature projection images, and obtaining global coordinates of the object in a global coordinate system of the imaging device on the basis of the projection coordinates of the object. The object detection system may further include a display configured to display the foregoing feature projection images.

According to yet another aspect of the present invention, a computer-readable medium is provided. The computer-readable medium has instructions thereon, and when executed by a processor, the instructions cause the processor to perform the steps of the object detection method as described above.

According to yet another aspect of the present invention, an imaging device is provided. The imaging device comprises the object detection system as described above.

These and other features and aspects of the present invention will become clearer through the detailed description with reference to the drawings hereinbelow.

### BRIEF DESCRIPTION OF THE DRAWINGS

To obtain a better understanding of the present invention in detail, please refer to the embodiments for a more detailed description of the present invention as briefly summarized above. Some embodiments are illustrated in the drawings. In order to facilitate a better understanding, the same symbols have been used as much as possible in the figures to mark the same elements that are common in the various figures. It should be noted, however, that the drawings only illustrate the typical embodiments of the present invention and should therefore not be construed as limiting the scope of the present invention as the present invention may allow other equivalent embodiments. In the figures:

FIG. 1 is a schematic perspective view of an exemplary imaging system according to an embodiment of the present invention.

FIG. 2 is a schematic block diagram of an exemplary imaging system according to an embodiment of the present invention.

FIG. 3A shows a series of slice images according to an embodiment of the present invention.

FIG. 3B shows another series of slice images according to an embodiment of the present invention.

FIG. 3C shows a three-dimensional (3D) image after volume rendering performed according to the series of slice images of FIG. 3B.

FIG. 4A shows a slice image under a large display field of view (FOV) according to an embodiment of the present invention.

FIG. 4B shows an image under a small display FOV for a part of the slice image of FIG. 4A.

FIG. 5 is an exemplary flowchart of an object detection method according to an embodiment of the present invention.

FIG. 6 shows three orthogonal plane feature projection images according to an embodiment of the present invention.

FIG. 7A and FIG. 7B respectively show an axial plane tomographic image and a max intensity projection image of a needle object according to an embodiment of the present invention.

FIG. 8A-FIG. 8C each show a user interface including conventional CT images (left side) and a corresponding multi-oblique plane reconstruction (MPR) image (right side).

FIG. 9 is an exemplary block diagram of an object detection system according to an embodiment of the present invention.

It can be expected that the elements in one embodiment of the present invention may be advantageously applied to the other embodiments without further elaboration.

### DETAILED DESCRIPTION

Specific embodiments of the present invention will be described below. It should be noted that in the specific description of these embodiments, for the sake of brevity and conciseness, the present specification cannot possibly describe all of the features of the actual embodiments in detail. It should be understood that in the actual implementation process of any embodiment, just as in the process of any engineering project or design project, a variety of specific decisions are often made to achieve specific goals of developers and to meet system-related or business-related constraints, which may also vary from one embodiment to another. Moreover, it can also be understood that although the efforts made in such development processes may be complex and lengthy, for those skilled in the art related to the disclosure of the present invention, some changes in design, manufacturing, production or the like based on the technical disclosure of the present invention are only conventional technical means, and the content of the present invention should not be construed as insufficient. In another aspect, in the following description, numerous specific details are set forth in order to provide a thorough understanding of the present invention, but it should be understood by those skilled in the art that the present invention may be practiced without some or all of these specific details. Therefore, the present invention is not limited to the specific embodiments disclosed below.

Furthermore, it can further be understood that the various embodiments shown in the drawings are illustrative and that the drawings are not necessarily drawn to scale.

In the present disclosure, unless defined otherwise, technical terms or scientific terms used in the claims and description should have the usual meanings that are understood by those of ordinary skill in the technical field to which the present invention pertains. The terms “first” and “second” and similar terms used in the description and claims of the patent application of the present invention do not denote any order, quantity, or importance, but are merely intended to distinguish between different constituents. The terms “one” or “a/an” and similar terms do not express a limitation of quantity, but rather that at least one is present. The terms “include” or “comprise” and similar words indicate that an element or object preceding the terms “include” or “comprise” encompasses elements or objects and equivalent elements thereof listed after the terms “include” or “comprise”, and do not exclude other elements or objects. The terms “connect” or “link” and similar words are not limited to physical or mechanical connections, and are not limited to direct or indirect connections.

In the present disclosure, the term “scan width” may refer to the total width of a region covered by an examination imaging scheme, i.e., the total thickness of various image slices obtained by a detector through scanning. The term “scan accuracy” may refer to the thickness of a single image slice. The term “tap cycle time” may refer to the duration of time from the start of exposure of an imaging device to the generation of a desired complete image. Taking a CT imaging system as an example, if the gantry rotation time and exposure time require 0.5 seconds, and the imaging time requires 1.5 seconds, then the tap cycle time of the system is 2.0 seconds. The term “subject under examination” may include both living subjects (such as humans, animals, and so on) and inanimate objects (such as luggage, implants, manufactured parts, and so on). For example, the subject may generally include, but is not limited to, human patients, animals, or other objects on which various imaging devices can perform detection.

An XYZ three-dimensional coordinate system is used herein to represent three orthogonal planes, namely, an XY plane, an XZ plane, and a YZ plane. It should be understood that any other suitable three-dimensional coordinate system may be used in the present invention. In an embodiment where the imaging device is a medical imaging device, the three orthogonal planes may generally be an axial plane, a sagittal plane, and a coronal plane of the subject.

An imaging system that can be used to implement the technology of the present invention will be described in detail below with reference to the drawings.

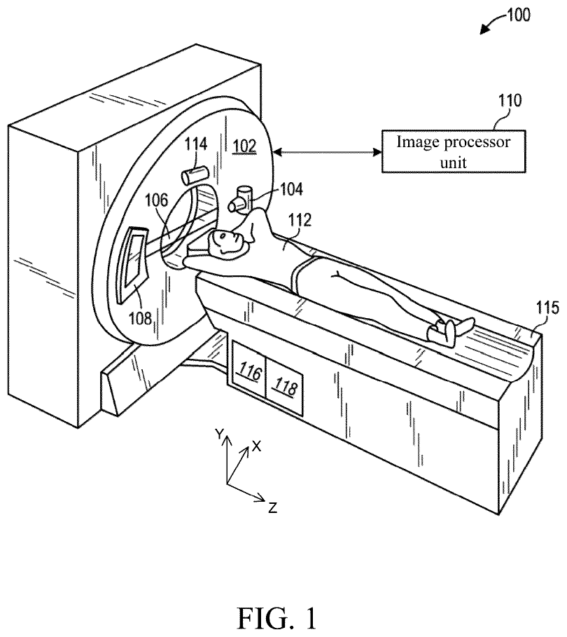

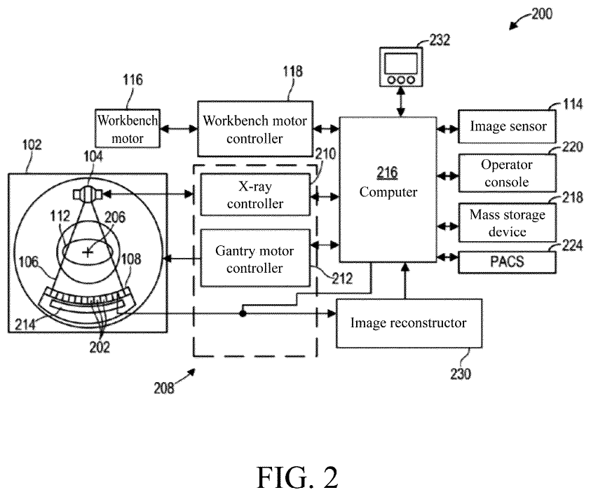

FIGS. 1 and 2 provide an exemplary imaging system, such as a CT imaging system. The imaging system can be used to detect an object in an image in accordance with the technology of the present invention.

While the present invention is described in combination with a CT imaging system, it should be understood that the present invention may also be applied to any other suitable type of imaging system, including but not limited to a baggage x-ray machine, a medical imaging system, etc. In addition to CT, the medical imaging system may include other medical imaging modalities, such as a magnetic resonance imaging (MRI) system, a C-arm imaging system, a positron emission tomography (PET) system, a single photon emission computed tomography (SPECT) system, an interventional imaging system (such as angiography, biopsy), an ultrasound imaging system, an x-ray radiation imaging system, an x-ray fluoroscopy imaging system, etc. Different types of imaging systems are applicable for detection of corresponding objects. The object may be any type of suitable object. As an example, a baggage x-ray machine is suitable for detecting specific articles in baggage. For the medical imaging system, detectable objects include interventional objects (such as needles, endoscopes, implants, catheters, guide wires, dilators, ablators, contrast agents, etc.), lesions (such as tumors, etc.), bones, organ tissue structures, vascular structures, etc. In another aspect, for example, in addition to being used in the medical field, the CT imaging system may be used for, for example, part inspection and the like in the manufacturing industry.

FIG. 1 shows an exemplary imaging system 100. The imaging system 100 is configured to image a subject under examination 112. In some embodiments of the present disclosure, the imaging system 100 may be a CT imaging system, and the term “subject” may be used interchangeably with “patient”. However, it should be understood that, in at least some examples, a patient is a type of subject that can be imaged by a CT system, and the subject may include the patient. In some embodiments, the imaging system 100 may include a gantry 102. The gantry 102, in turn, may include at least one x-ray radiation source 104, and the x-ray radiation source 104 may include an x-ray target made of graphite and metal. The at least one x-ray radiation source 104 may be configured to emit an x-ray radiation beam 106 to image the subject. Specifically, the radiation source 104 is configured to emit an x ray 106 toward a detector array 108 positioned on the opposite side of the gantry 102. Although only a single radiation source 104 is illustrated in FIG. 1, in other embodiments, a plurality of radiation sources may be used to emit a plurality of x-rays 106, so as to obtain projection data corresponding to the subject at different energy levels.

In some embodiments, the imaging system 100 may include an imaging sensor 114 positioned on or outside the gantry 102. As shown in the figure, the imaging sensor 114 is positioned on the outside of the gantry 102 and is oriented to image the subject when the subject 112 is at least partially outside the gantry 102. The imaging sensor 114 may include a visible light sensor, and/or an infrared (IR) sensor provided with an IR light source. The IR sensor may be a three-dimensional depth sensor, such as a time-of-flight (TOF) sensor, a stereo sensor, or a structured light depth sensor. The three-dimensional depth sensor is operable to generate a three-dimensional depth image. In other embodiments, the IR sensor may be a two-dimensional IR sensor, and the two-dimensional IR sensor is operable to generate a two-dimensional IR image. In some embodiments, the two-dimensional IR sensor may be used to infer a depth from knowledge of IR reflection phenomena, so as to estimate a three-dimensional depth. Regardless of whether the IR sensor is a three-dimensional depth sensor or a two-dimensional IR sensor, the IR sensor can be configured to output a signal for encoding an IR image to a suitable IR interface. The IR interface can be configured to receive, from the IR sensor, the signal for encoding an IR image. In other examples, the imaging sensor may further include other components, such as a microphone, so that the imaging sensor can receive and analyze directional and/or non-directional sound from the subject being observed and/or other sources.

In some embodiments, the imaging system 100 may include a processor such as an image processor 110. The processor 110 may be configured for implementing the object detection technology of the present invention, which will be described in further detail below. The processor 110 may also be configured to reconstruct an image of a target volume of the subject 112 by using a suitable reconstruction method (such as an iterative or analytical image reconstruction method). For example, the image processor 110 may reconstruct the image of the target volume of the subject 112 by using an analytical image reconstruction method such as filtered back projection (FBP). As another example, the image processor 110 may reconstruct the image of the target volume of the subject 112 by using an iterative image reconstruction method (such as adaptive statistical iterative reconstruction (ASIR), conjugate gradient (CG), maximum likelihood expectation maximization (MLEM), model-based iterative reconstruction (MBIR), or the like).

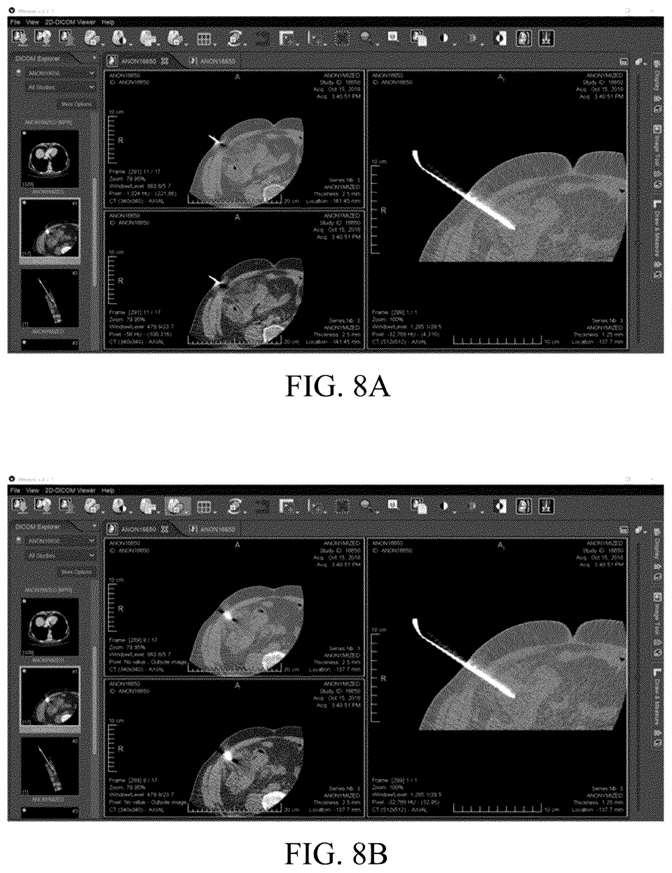

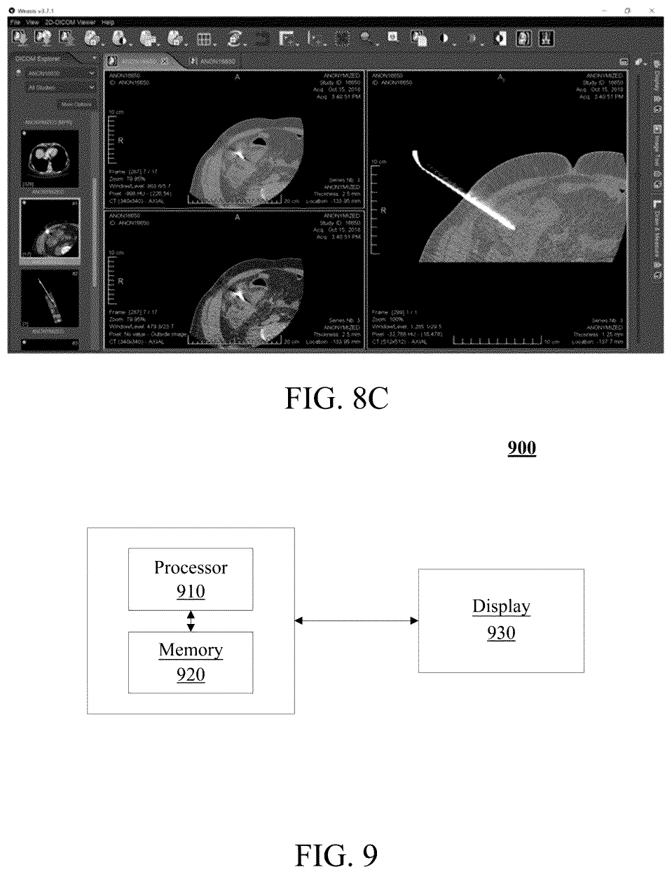

In some embodiments, the image processor 110 may be configured to perform multi-oblique plane reconstruction (MPR) on the basis of the object detection technology of the present invention. MPR is a 3D data set displaying method that can generate sectional images, such as raw two-dimensional (2D) coronal, sagittal, and axial images. Curve MPR reconstructs sectional images perpendicular to a specific curve created by a user. Object detection may be used as the basis for automatic MPR and tracking. Such automatic MPR based on object detection may display the overall appearance of an object and the region of interest of the subject 112 in an image, so that a physician can accurately assess the distance of the object (e.g., a puncture needle) from a specific part (e.g., tumor) in the region of interest, thereby providing better guidance to the physician, as shown in FIGS. 8A-8C. Furthermore, a plurality of consecutive reconstructed images may also show a trajectory of the object.

The imaging system 100 may include a workbench 115, and a subject to be imaged can be positioned on the workbench 115. The workbench 115 may be electrically powered, so that a vertical position and/or a horizontal position of the workbench can be adjusted. Therefore, the workbench 115 may include a motor 116 and a motor controller 118. The workbench motor controller 118 moves the workbench 115 by adjusting the motor 116, so as to properly position the subject in the gantry 102 to acquire projection data corresponding to the target volume of the subject 112. The workbench motor controller 118 may adjust the height of the workbench 115 (e.g., a vertical position relative to the ground on which the workbench is located) and the lateral position of the workbench 115 (e.g., a horizontal position of the workbench along an axis parallel to an axis of rotation of the gantry 102).

FIG. 2 shows an exemplary imaging system 200 similar to the imaging system 100 in FIG. 1. In an embodiment, the system 200 includes a detector array 108 (see FIG. 1). The detector array 108 further includes a plurality of detector elements 202, which together collect the x-ray beam 106 (see FIG. 1) passing through the subject 112 to acquire corresponding projection data. The system 200 stores said projection data in a storage device 218. The storage device 218 may include, for example, a hard disk drive, a floppy disk drive, a compact disc-read/write (CD-R/W) drive, a digital versatile disc (DVD) drive, a flash drive, and/or a solid-state storage device. Therefore, in an embodiment, the detector array 108 is made in a multi-slice configuration including a plurality of rows of units or detector elements 202. In such configurations, one or more additional rows of detector elements 202 are arranged in a parallel configuration to acquire projection data.

In some embodiments, the system 200 is configured to traverse different angular positions around the subject 112 to acquire required projection data. Therefore, the gantry 102 and components (such as the radiation source 104 and the detector 202) mounted thereon can be configured to rotate about a center of rotation 206 to acquire, for example, projection data at different energy levels. Alternatively, in embodiments in which a projection angle with respect to the subject 112 changes over time, the mounted components may be configured to move along a substantially curved line rather than a segment of a circumference.

In an embodiment, the system 200 includes a control mechanism 208 to control movement of the components, such as the rotation of the gantry 102 and the operation of the x-ray radiation source 104. In some embodiments, the control mechanism 208 further includes an x-ray controller 210. The x-ray controller 210 is configured to provide power and timing signals to the radiation source 104. Additionally, the control mechanism 208 includes a gantry motor controller 212, configured to control the rotational speed and/or position of the gantry 102 on the basis of imaging requirements.

In some embodiments, the control mechanism 208 further includes a data acquisition system (DAS) 214. The DAS is configured to sample analog data received from the detector elements 202, and convert the analog data into digital signals for subsequent processing. The data sampled and digitized by the DAS 214 is transmitted to a computing device 216. In one example, the computing device 216 stores data in a storage device 218. Although only a single computing device 216 is shown in FIG. 2, in some examples, the computing device 216 may be distributed across a plurality of physical devices.

Additionally, the computing device 216 provides commands and parameters to one or more among the DAS 214, the x-ray controller 210, and the gantry motor controller 212 to control system operations, such as data acquisition and/or processing. In some embodiments, the computing device 216 controls system operations on the basis of operator input. The computing device 216 receives the operator input by means of an operator console 220 that is operably coupled to the computing device 216, the operator input including, for example, commands and/or scan parameters. The operator console 220 may include a keyboard (not shown) or a touch screen to allow the operator to specify commands and/or scan parameters.

Although FIG. 2 shows only one operator console 220, more than one operator console may be coupled to the system 200, and, for example, is used to input or output system parameters, request examination, and/or view images. Moreover, in some embodiments, the system 200 may be coupled to, for example, a plurality of displays, printers, workstations, and/or similar devices located locally or remotely within an institution or hospital or in a completely different location by means of one or more configurable wired and/or wireless networks (such as the Internet and/or a virtual private network).

For example, in an embodiment, the system 200 includes or is coupled to a picture archiving and communication system (PACS) 224. In an exemplary embodiment, the PACS 224 is further coupled to a remote system (such as a radiology information system or a hospital information system), and/or an internal or external network (not shown) to allow operators in different locations to provide commands and parameters and/or acquire access to image data.

The computing device 216 uses operator-provided and/or system-defined commands and parameters to operate the workbench motor controller 118. The workbench motor controller 118 can in turn control the electrically powered workbench 115. For example, the computing device 216 may send a command to the motor controller 118, so as to instruct the motor controller 118 to adjust the vertical position and/or the lateral position of the workbench 115 by means of the motor 116.

As described previously, the DAS 214 samples and digitizes the projection data acquired by the detector elements 202. Subsequently, an image reconstructor 230 uses the sampled and digitized X-ray data to perform high-speed reconstruction. Although the image reconstructor 230 is shown as a separate entity in FIG. 2, in some embodiments, the image reconstructor 230 may form a part of the computing device 216. Alternatively, the image reconstructor 230 may not be present in the system 200, and the computing device 216 may instead perform one or more functions of the image reconstructor 230. In addition, the image reconstructor 230 may be located locally or remotely, and may be operably connected to the system 100 by using a wired or wireless network. Specifically, in an exemplary embodiment, computing resources in a “cloud” network cluster may be used for the image reconstructor 230.

In an embodiment, the image reconstructor 230 stores reconstructed images in the storage device 218. Alternatively, the image reconstructor 230 transmits the reconstructed images to the computing device 216 to generate usable subject information for diagnosis and evaluation. In some embodiments, the computing device 216 transmits the reconstructed images and/or subject information to a display 232, the display being communicatively coupled to the computing device 216 and/or the image reconstructor 230. In an embodiment, the display 232 allows an operator to evaluate an imaged anatomical structure. The display 232 may further allow the operator to select a volume of interest (VOI) and/or request subject information by means of, for example, a graphical user interface (GUI) for subsequent scanning or processing.

In some examples, the computing device 216 may include computer-readable instructions, and the computer-readable instructions are executable to send, according to an examination imaging scheme, commands, and/or control parameters to one or more among the DAS 214, the x-ray controller 210, the gantry motor controller 212, and the workbench motor controller 226. The examination imaging scheme includes a clinical task/intent of the examination. For example, the clinical intent may inform a goal (e.g., a general scan or lesion detection, an anatomical structure of interest, a critical-to-quality (CTQ) parameter, or another goal) of a procedure on the basis of a clinical indication, and may further limit the required subject position and orientation (e.g., supine and feet first) during a scan. The operator of the system 200 may then position the subject on the workbench according to the subject position and orientation specified by the imaging scheme. Further, the computing device 216 may set and/or adjust various scan parameters (e.g., a dose, a gantry rotation angle, kV, mA, and an attenuation filter) according to the imaging scheme. For example, the imaging scheme may be selected by the operator from a plurality of imaging schemes stored in a memory on the computing device 216 and/or a remote computing device, or the imaging scheme may be automatically selected by the computing device 216 according to received subject information.

Techniques that may be used to reduce the time overhead for object detection will be described in detail below with reference to the drawings.

As described previously, the time overhead for object detection increases with the increase in the number of images, image resolution, etc. The number of images, in turn, increases with the increase in scan width, scan accuracy, etc. The image resolution is proportional to the number of pixels. On the basis of the foregoing, various methods have been conceived in the present invention to reduce the time overhead for object detection.

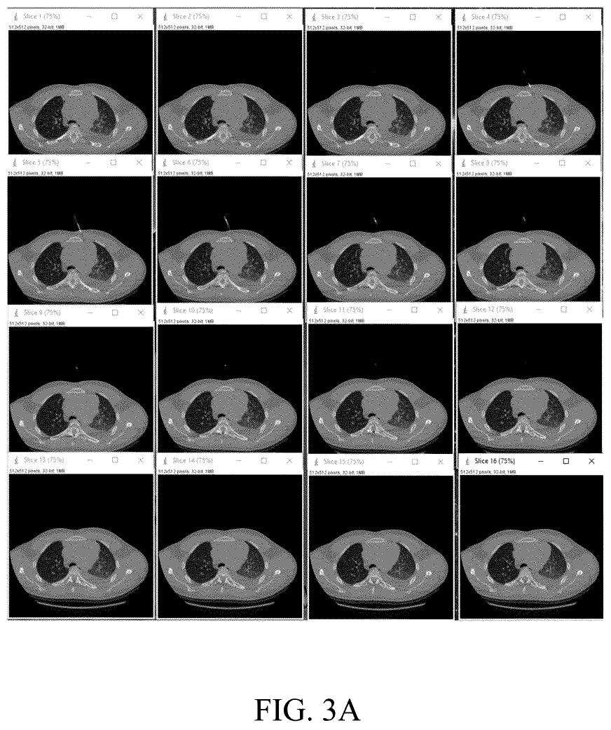

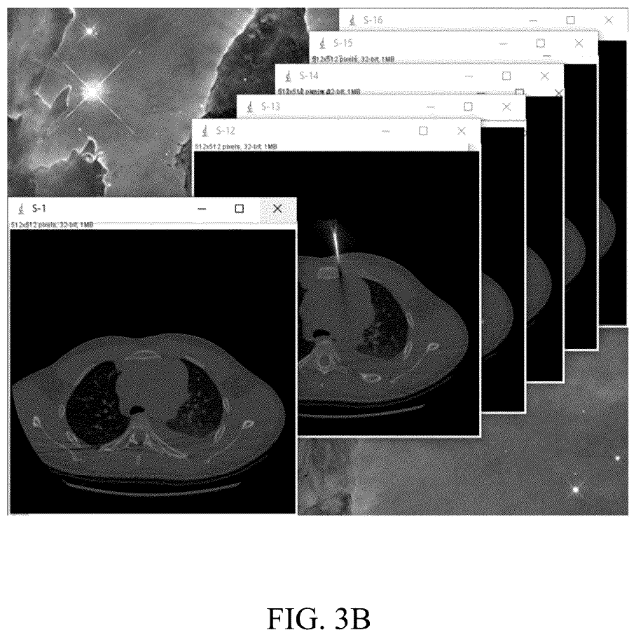

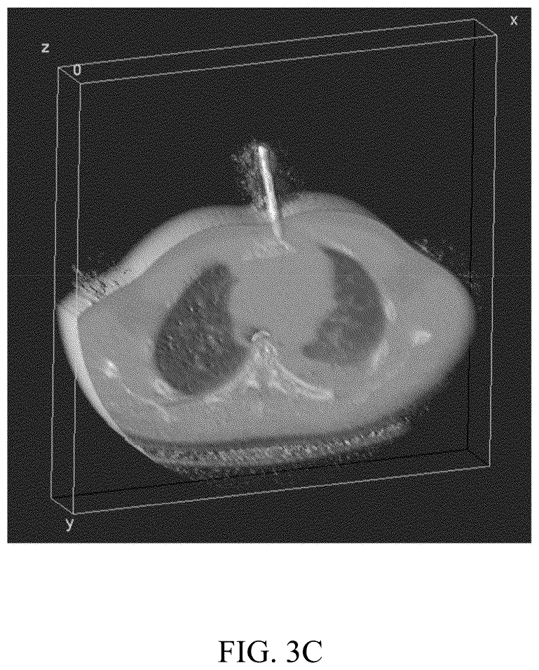

As shown in FIG. 3A, there are shown 16 slice images (Slice 1-Slice 16) obtained by scanning a region of interest of the subject 112 by, for example, the imaging system 100 or 200 shown in FIGS. 1 and 2. The scan accuracy thereof is 0.625 mm, and the scan width is 10 mm. The resolution of each slice image is 512×512 pixels. The object to be detected by the scanning process is a needle, such as a puncture needle, a biopsy needle, etc. A needle is an interventional instrument with a large aspect ratio. For imaging technology, a needle is approximately a two-dimensional (2D) rotating body. The needle of the present invention may be made of any suitable material, such as metal. The needle may generally have a specification of, for example, 25 G to 10 G, and the needle of this specification has an outer diameter of about 0.515 mm to 3.404 mm. The needle may include a needle core and a needle housing enclosing the needle core, so as to extract human tissue, for example. The needle is not always parallel to the imaging section when penetrating a subject under examination (such as human body), so that the needle needs to be identified by means of image processing, thereby enabling a sectional image in which the needle is located to be automatically generated so as to provide guidance for the physician, such as indicating the position or distance of the needle relative to a specific part (e.g., suspected or confirmed tumor) in the region of interest.

Conventionally, detection for the object needle can be performed on the 16 slice images image by image, for example, by one or more methods among a threshold segmentation method, a PCA enhancement method, a Gaussian convolution method, a Hessian matrix method, a D-Test method, and an AI method. If the detection time taken for each slice image is constant, the time overhead for object detection is O(n), where n is the number of slice images. If an iterative algorithm needs to be applied to one or more slice images to remove interferences such as bones (because the CT values of both the needle and the bones are high), the detection time for these slice images increases accordingly, making the time overhead for object detection much more complex. In summary, the time overhead T for object detection can be calculated by formula (1) below.

$$T = {\sum }_{i = 1}^{n} {t}_{i} \qquad ( 1 )$$

where tᵢ represents the object detection time taken for a single slice image, and may be associated with factors such as the resolution of the slice image; and n represents the number of slice images, and may be associated with factors such as the scan width, scan accuracy, etc.

In the example shown in FIG. 3A (CT intervention supporting three-dimensional automated MPR), the detection of the object needle generally takes a total of about 4-5 seconds, such as 4.336 seconds, where the x-ray exposure time may be about 0.234 seconds.

It should be understood that the object to be detected may not appear on all slice images. In the example shown in FIG. 3A, the needle can be detected in Slice 4 to Slice 12. Furthermore, since the needle is approximately two-dimensional, the aspect ratio of the needle in the image (depending on the angle of the needle with respect to the scanning plane) is important for the detection of the needle. If the needle enters the human body at a large angle, the needle length in the slice image will be small (the actual length of the needle is relatively longer). If the needle enters the human body at an angle perpendicular to the body surface, the needle length in the slice image will be close to the actual length of the needle.

In some embodiments of the present invention, the time overhead T for object detection may be directly limited by setting an upper limit on the detection time taken for the slice image. For example, after a single exposure, only a duration of, for example, 3 seconds is allowed for detecting the needle. If the needle is not detected within the 3 seconds, the detection is discarded and the physician is asked to use a plane layer image instead.

In some other embodiments of the present invention, the time overhead T for object detection may be reduced by adjusting various factors (such as scan width, scan accuracy, image resolution, the number of image pixels, etc.) that affect the time overhead for object detection. Such a method may avoid detection failures to a large extent compared with a method that directly limits the time overhead T.

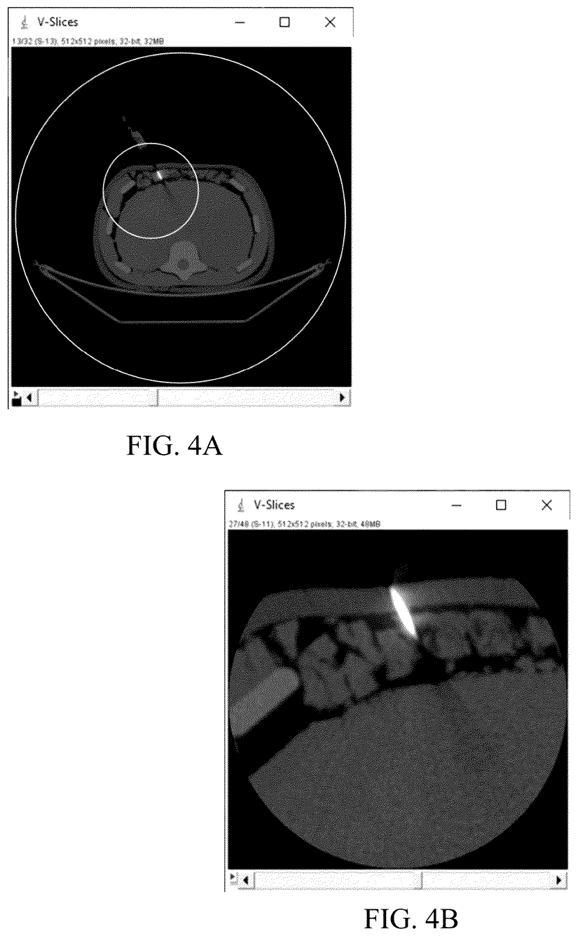

For example, in an example, considering that the time taken to detect an object in an image increases as the number of image pixels increases, the time overhead T for object detection may be reduced by switching a large display field of view (FOV) to a small display FOV to eliminate the pixel dot matrix on the air area in the image as much as possible (as shown in FIGS. 4A and 4B). FIG. 4A shows a maximum display FOV of 50 cm (centimeters), as indicated by the outer circle in the figure. FIG. 4B shows the part represented by the small circle in FIG. 4A, which is a smaller display FOV of 10 cm. In actual imaging operations, physicians generally will directly select a region of interest represented by the small circle for imaging (see FIG. 4B). For the image shown in FIG. 4B, excluding the air area has a relatively small impact on the calculation amount of object detection, and accordingly, the effect of reducing the time overhead for object detection will also be relatively limited.

In another example, considering that the time overhead for object detection increases as the number of images increases, the time overhead T for object detection can be reduced by reducing the number n of slice images. Further, the scan width generally depends on the examination imaging scheme, so for a particular object detection process, the number of generated slice images can typically be reduced by reducing the image scan accuracy. For example, in the case of a 10 mm scan width, 16 slice images can be generated at a scan accuracy of 0.625 mm, as shown in FIG. 3A. When the scan accuracy is reduced to 1.25 mm, the number of slice images is proportionally reduced to 8, and correspondingly, the time overhead T for object detection can be reduced to one half of that at the scan accuracy of 0.625 mm.

In yet another example, considering that the time taken to detect an object in a single slice image increases with the increase in image resolution, the object detection time tᵢ taken for each slice image may be reduced by reducing the image resolution of one or more slice images, thereby reducing the time overhead T for object detection as a whole. For example, if the object detection process is performed by replacing an image having a 512×512 dot matrix with an image having a 256×256 dot matrix, the object detection time tᵢ taken for the slice image can be reduced to a quarter of the time before replacement.

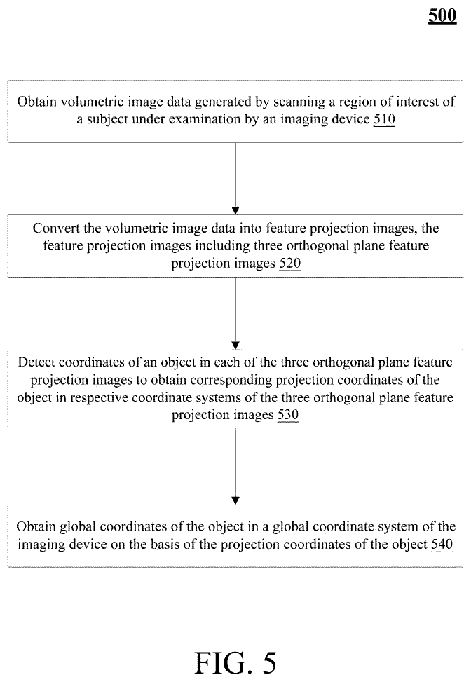

For example, a reduction in scan accuracy and/or image resolution may result in a loss of detection accuracy. Specifically, reducing the scan accuracy reduces the detection accuracy in the slice direction (e.g., a Z direction). Reducing the image resolution reduces the detection accuracy on a section (e.g., an XY plane). To achieve a substantial reduction in the time overhead for object detection without the loss of detection accuracy, the present invention further provides an object detection method 500 as shown in FIG. 5. In the method 500, object detection is performed by using feature projection images on three orthogonal planes. Under the same conditions as those in the example shown in FIG. 3A, the time overhead for object detection in the method shown in FIG. 5 can be reduced to 1.68 seconds.

As used herein, the term “feature” may refer to a characteristic of an object to be identified that is distinct from a subject. The term “feature projection image” may be, for example, a max intensity projection (MIP) image, an average intensity projection (AIP) image, a min intensity projection (mIP) image, a standard deviation projection (SDP) image, and so on, or various combinations thereof. The feature projection image may be specifically selected depending on the characteristics of the object and its surrounding objects. For example, a significant feature of a needle object made of metal with respect to human tissue may be that the image CT value of the needle is higher. Therefore, detection of the needle object may use a max intensity projection image. For another example, for a low-dose high noise image, an average intensity projection image may be used. For yet another example, a min intensity projection image may be suitable for an object with a lower intensity than that of the periphery thereof, such as an instrument made of fiber relative to bones. Since the image CT value of fiber is much lower than that of bones, the fiber object can be detected using a min intensity projection image. For an object and an examination subject with significant variations in intensity, a standard deviation projection image may also be used to detect the object. Furthermore, it is also possible to use a combination of a plurality of feature projection images, such as the difference between a max intensity projection image and a min intensity projection image, to enhance features of the object to be detected. For images from multiple sources (CT/x-ray/MRI) or for images with multiple energy spectra, synthetic feature projection images with different sources or different energy spectra may be used.

The three orthogonal planes generally refer to an XY plane, an XZ plane, and a YZ plane in an XYZ three-dimensional coordinate system, but may also be other suitable three orthogonal planes. In the CT imaging systems 100 and 200 shown in FIGS. 1 and 2, the three orthogonal planes generally refer to the axial, sagittal, and coronal planes of the subject 112. For an image lacking sufficient positional reference information, it is possible to select a plane parallel to the scan plane as the axial plane, select a plane parallel to the horizontal plane as the coronal plane, and select a plane perpendicular to the two planes as the sagittal plane. In an embodiment using a puncture needle, when there is puncture planning information (such as a needle entry point and a puncture target point), it is possible to select a plane perpendicular to the needle entry point and the puncture target point as the coronal plane, select a plane including the needle entry point and the puncture target point and the three o'clock (horizontal) direction of the scan plane as the axial plane, and select a plane perpendicular to the two planes as the sagittal plane. The advantage of such a selection is that when the trajectory of the puncture and the planned path are highly coincident, the needle in the coronal plane will degenerate into a gathering point, and the projections of the axial and sagittal planes have projections that coincide with the actual length of the needle. Further, according to the relative positional relationship between the operator of the imaging device and the patient, it is also possible to select a plane coinciding with the observation direction of the operator as the sagittal plane, select a plane in a direction perpendicular to the observation direction as the axial plane, and select a plane perpendicular to the two planes as the coronal plane.

The object disclosed herein may be at least partially located in the subject (e.g., the subject under examination 112 shown in FIGS. 1 and 2). In some embodiments, the object may be a rotating body. The object may have two-dimensional or three-dimensional features. As described previously, the object may include, but is not limited to, an interventional object, a lesion, a bone, an organ tissue structure, a vascular structure, etc. The object may also be a defect in a part such as a crack or the like. For example, an interventional object may include, but is not limited to, a needle, an endoscope, an implant, a catheter, a guide wire, a dilator, an ablator, a contrast agent, etc. The lesion may include, but is not limited to, a tumor, a cyst, a nodule, an ulcer, a plaque, etc. The bone may include, but is not limited to, a skeleton, a joint, etc. The interventional needle may include, but is not limited to, a puncture needle, a biopsy needle, an ablation needle, a nerve block needle, etc. The implant may include, but is not limited to, a cardiac pacemaker, an implantable defibrillator, a stent, an artificial joint, an artificial valve, an artificial cochlear implant, a bone screw, an implant dialyzer, a dental implant, an embolizer, etc.

The object detection method 500 described herein may include steps 510 to 540. In step 510, volumetric image data generated by scanning a region of interest of a subject under examination by an imaging device can be obtained. The imaging device may be, for example, a CT imaging device as shown in FIG. 1 or 2. In the embodiment shown in FIGS. 1 and 2, the subject is a human patient. The obtained volumetric image data is used as projection data, which may be provided to a processor for processing, or may be stored in a storage device of an imaging device (such as the storage device 218 shown in FIG. 2) for subsequent processing.

In step 520, the volumetric image data may be converted into feature projection images including three orthogonal plane feature projection images. With respect to the above embodiment in which the time overhead for object detection varies with the change in the number of images, in the method 500, object detection is performed by using three feature projection images on three mutually orthogonal planes regardless of the number of slice images, so the time overhead for object detection is the time taken for performing detection on only three feature projection images. Therefore, the time overhead for object detection is greatly reduced, and can be substantially constant. In addition, the feature projection image of a plane where the section is located, among the three orthogonal planes, has an image dot matrix with the same number of pixels as that of the conventional slice image, such as 512×512, 256×256, or 1024×1024. Also, the number of pixels in one dimension (row or column) of each of the other two feature projection images corresponds to the number of pixels in a row or column of a single slice image dot matrix, and the number of pixels in the other dimension is equal to the number of slice images. Since the number of slice images (such as 16, 32, 64, etc.) is generally much smaller than the number of pixels (such as 256, 512, 1024, etc.) in the row or column of the pixel dot matrix of the slice image, the pixel dot matrix of the other two feature projection images is much smaller than the pixel dot matrix of the feature projection image on the section, so that the time taken for performing detection on the three orthogonal plane feature projection images can be much less than the time taken for performing detection on conventional three slice images, thereby further reducing the time overhead for object detection.

As an example, an exemplary process of obtaining a max intensity projection (MIP) image from volumetric image data will be described below with reference to FIGS. 3B and 3C.

FIG. 3B shows 6 slice images in another series of 16 slice images generated by a body scan similar to that of FIG. 3A. The scan accuracy thereof is 1.25 mm, and the scan width is 20 mm. The resolution of each slice image is also 512×512 pixels. According to the 16 slice images of FIG. 3B, by means of volume rendering, a three-dimensional image as shown in FIG. 3C can be obtained, wherein an XY plane may be the axial plane of the subject, an XZ plane may be the coronal plane of the subject, and a YZ plane may be the sagittal plane of the subject. In light of the example shown in FIGS. 3B-3C, the values of respective pixels in the slice image are represented using a two-dimensional array with a 512×512 size. 42 pixel values in 6 columns and 7 rows on the first, second, third and sixteenth slice images among the 16 slice images in the example shown in FIG. 3B will be schematically given below, and the remaining pixel values are not shown but are similar.

Two-dimensional array example of first slice image (S-1):

| | | | | | | |
|---|---|---|---|---|---|---|
| 31 | 119 | 60 | 153 | 209 | . . . | 95 |
| 236 | 23 | 95 | 193 | 142 | . . . | 246 |
| 117 | 109 | 28 | 11 | 129 | . . . | 44 |
| 244 | 88 | 64 | 43 | 195 | . . . | 153 |
| 160 | 194 | 57 | 149 | 7 | . . . | 85 |
| 203 | 172 | 218 | 234 | 242 | . . . | 214 |
| . . . | . . . | . . . | . . . | . . . | . . . | . . . |
| 176 | 7 | 106 | 125 | 89 | . . . | 12 |

Two-dimensional array example of second slice image (S-2):

| | | | | | | |
|---|---|---|---|---|---|---|
| 134 | 17 | 51 | 62 | 108 | . . . | 17 |
| 208 | 94 | 208 | 64 | 62 | . . . | 243 |
| 94 | 221 | 65 | 42 | 178 | . . . | 0 |
| 32 | 152 | 107 | 51 | 5 | . . . | 53 |
| 168 | 39 | 18 | 148 | 19 | . . . | 22 |
| 218 | 54 | 224 | 5 | 11 | . . . | 161 |
| . . . | . . . | . . . | . . . | . . . | . . . | . . . |
| 2 | 150 | 206 | 202 | 210 | . . . | 166 |

Two-dimensional array example of third slice image (S-3):

| | | | | | | |
|---|---|---|---|---|---|---|
| 154 | 10 | 192 | 111 | 110 | . . . | 127 |
| 3 | 81 | 88 | 19 | 51 | . . . | 250 |
| 146 | 158 | 74 | 80 | 221 | . . . | 162 |
| 79 | 155 | 12 | 236 | 112 | . . . | 170 |
| 94 | 39 | 26 | 124 | 238 | . . . | 231 |
| 144 | 40 | 52 | 156 | 99 | . . . | 63 |
| . . . | . . . | . . . | . . . | . . . | . . . | . . . |
| 42 | 203 | 97 | 102 | 39 | . . . | 51 |

Two-dimensional array example of sixteenth slice image (S-16):

| | | | | | | |
|---|---|---|---|---|---|---|
| 219 | 6 | 101 | 37 | 150 | . . . | 174 |
| 97 | 183 | 15 | 217 | 222 | . . . | 185 |
| 44 | 43 | 19 | 89 | 154 | . . . | 201 |
| 174 | 52 | 84 | 18 | 106 | . . . | 146 |
| 163 | 188 | 79 | 101 | 139 | . . . | 158 |
| 18 | 159 | 235 | 70 | 219 | . . . | 81 |
| . . . | . . . | . . . | . . . | . . . | . . . | . . . |
| 72 | 18 | 91 | 107 | 145 | . . . | 147 |

Since the slice image is parallel to a vertical scanning center plane, the vertical scanning center plane may be selected as an axial plane of projection. A max intensity projection (MIP) image of the axial plane can be obtained by acquiring the maximum value of each selected pixel from among corresponding pixel values thereof in the two-dimensional arrays of the respective slice image. For example, for the top-left pixel, the corresponding pixel values in the first, second, third, and sixteenth slice images are 31, 134, 154 and 219, respectively. Assuming that the values of the top-left pixel in the fourth to fifteenth slice images are all less than 219, the value of the top-left pixel of the MIP image is 219. The same process applies to other pixels. The two-dimensional array representation of the max intensity projection (MIP) image of the axial plane in the example shown in FIGS. 3B-3C can be as shown below:

| | | | | | | |
|---|---|---|---|---|---|---|
| 219 | 119 | 192 | 153 | 209 | . . . | 174 |
| 236 | 183 | 208 | 217 | 222 | . . . | 250 |
| 146 | 221 | 74 | 89 | 221 | . . . | 201 |
| 244 | 155 | 107 | 236 | 195 | . . . | 170 |
| 168 | 194 | 79 | 149 | 238 | . . . | 231 |
| 218 | 172 | 235 | 234 | 242 | . . . | 214 |
| . . . | . . . | . . . | . . . | . . . | . . . | . . . |
| 176 | 203 | 206 | 202 | 210 | . . . | 166 |

The two-dimensional array representations of the max intensity projection (MIP) images of the sagittal and coronal planes can be obtained in a similar manner. The difference is that the column of the sagittal plane dot matrix and the row of the coronal plane dot matrix are not 512 pixels but only 16 pixels (i.e., the number of slice images).

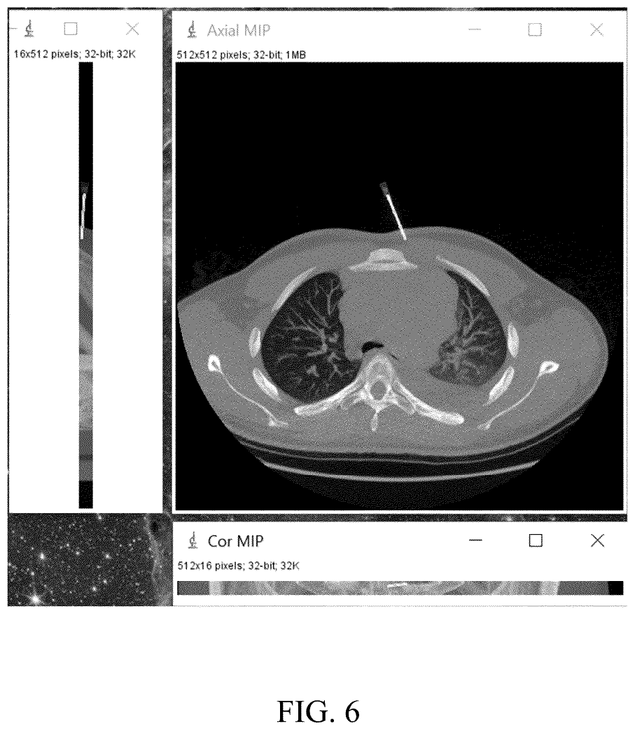

FIG. 6 shows an axial plane MIP image (Axial MIP), a sagittal plane MIP image (Sag MIP), and a coronal plane MIP image (Cor MIP) of the example shown in FIGS. 3B to 3C, in a main part, a left side part, and a bottom part of FIG. 6, respectively. The axial plane MIP image may have a 512×512 pixel dot matrix, the sagittal plane MIP image may have a 16×512 pixel dot matrix, and the coronal plane MIP image may have a 512×16 pixel dot matrix. Since the puncture needle is made of high-density metal, the part of the needle in the image is highlighted. Such embodiments may retain needle information to a maximum extent by using the max intensity projection.

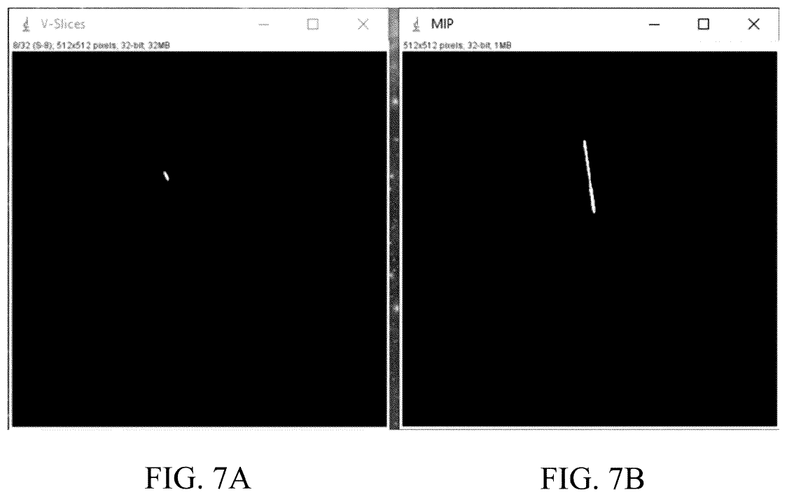

FIG. 7A shows an object (in this example, a needle) in a conventional axial plane slice image. FIG. 7B shows the object in an axial plane MIP image. By comparison, although the image specifications shown in FIGS. 7A and 7B are the same, the needle object has a larger aspect ratio in the MIP image, which further facilitates the detection of the needle object.

In step 530, coordinates of an object may be detected in each of the three orthogonal plane feature projection images to obtain corresponding projection coordinates of the object in respective coordinate systems of the three orthogonal plane feature projection images. In an embodiment of the present invention, the detection of the projection coordinates may be based on one or more methods among a threshold segmentation method, a PCA enhancement method, a Gaussian convolution method, a Hessian matrix method, a D-Test method, and an AI method.

Taking a CT medical imaging system as an example, according to common coordinate systems of CT scans, rows and columns of an axial plane MIP image correspond to the Y axis and the X axis, respectively, rows and columns of a sagittal plane MIP image correspond to the Y axis and the Z axis, respectively, and rows and columns of a coronal plane MIP image correspond to the Z axis and the X axis, respectively. Accordingly, the projection coordinates of the needle object detected in the axial plane MIP image may be expressed as (Axᵢ, Ayⱼ), the projection coordinates of the needle object detected in the sagittal plane MIP image may be expressed as (Syⱼ, Szₖ), and the projection coordinates of the needle object detected in the coronal plane MIP image may be expressed as (Cxᵢ, Czₖ), where i represents which column of pixels on the corresponding feature projection image the projection coordinates are, j represents which row of pixels on the corresponding feature projection image the projection coordinates are, and k represents which row or column of pixels on the corresponding feature projection image the projection coordinates are. In an example, M projection coordinates of the needle object may be detected in the axial plane MIP image, N projection coordinates of the needle object may be detected in the sagittal plane MIP image, and O projection coordinates of the needle object may be detected in the coronal plane MIP image.

Next, in step 540, the global coordinates of the object in a global coordinate system of the imaging device may be obtained on the basis of the projection coordinates of the object obtained in step 530.

In some embodiments, the projection coordinates may be converted into the global coordinates by formula (2) below:

$$[ ] = \frac{1}{2} ( [ \begin{matrix}{Ax}_{i} \\ {Ay}_{j} \\ 0\end{matrix} ] + [ \begin{matrix}0 \\ {Sy}_{j} \\ {Sz}_{k}\end{matrix} ] + [ \begin{matrix}{Cx}_{i} \\ 0 \\ {Cz}_{k}\end{matrix} ] ) \qquad ( 2 )$$

where [symbol] represents an estimated value. [symbol] represents a component of the global coordinates on the X axis, [symbol] represents a component of the global coordinates on the Y axis, [symbol] represents a component of the global coordinates on the Z axis, Axᵢ represents a component of the projection coordinates related to an XY orthogonal plane feature projection image among the three orthogonal plane feature projection images on the X axis, Ayⱼ represents a component of the projection coordinates related to the XY orthogonal plane feature projection image among the three orthogonal plane feature projection images on the Y axis, Syⱼ represents a component of the projection coordinates related to a YZ orthogonal plane feature projection image among the three orthogonal plane feature projection images on the Y axis, Szₖ represents a component of the projection coordinates related to the YZ orthogonal plane feature projection image among the three orthogonal plane feature projection images on the Z axis, Cxᵢ represents a component of the projection coordinates related to an XZ orthogonal plane feature projection image among the three orthogonal plane feature projection images on the X axis, and Czₖ represents a component of the projection coordinates related to the XZ orthogonal plane feature projection image among the three orthogonal plane feature projection images on the Z axis.

Taking the aforementioned CT medical imaging system as an example, the numbers M, N, and O of projection coordinates detected on the three feature projection images are not always equal, and are usually unequal, because the lengths of the projections are often unequal. Therefore, to facilitate conversion of two-dimensional projection coordinates into three-dimensional global coordinates, an interpolation operation can be performed on one or more of the projection coordinates on the axial plane MIP image, the sagittal plane MIP image, and the coronal plane MIP image, for example, each being divided into 100 equal parts. Thus, the projection coordinates on the axial plane MIP image, the sagittal plane MIP image, and the coronal plane MIP image can be expressed as (Axₗ, Ayₗ), (Syₗ, Szₗ) and (Cxₗ, Czₗ), respectively, where l=1, 2, 3, . . . 100, and formula (2) described above can be changed to formula (3) as shown below:

$$[ ] = \frac{1}{2} ( [ \begin{matrix}{Ax}_{l} \\ {Ay}_{l} \\ 0\end{matrix} ] + [ \begin{matrix}0 \\ {Sy}_{l} \\ {Sz}_{l}\end{matrix} ] + [ \begin{matrix}{Cx}_{l} \\ 0 \\ {Cz}_{l}\end{matrix} ] ) , l = 1 , 2 , 3 , … 100 \qquad ( 3 )$$

In an extreme case, one of the three feature projection images may degenerate to correspond to the periphery of the object. For example, when the travel trajectory of the needle object is perpendicular or substantially perpendicular to the coronal plane, the coronal plane MIP image may degenerate into a gathering point corresponding to the outer diameter of the needle object, and is no longer a linear object. In the case of degeneration of the coronal plane MIP image, the aspect ratio of the region covered by the coronal plane image dot matrix is less than 1.414, and the absolute area is equivalent to the sectional area of the detection object. At this time, the component Axᵢ of the projection coordinates corresponding to the axial plane MIP image on the X axis and the component Szₖ of the projection coordinates corresponding to the sagittal plane MIP image on the Z axis also correspondingly degenerate. In this case, the image of the needle object can be reconstructed mainly using the axial plane MIP image and the sagittal plane MIP image, and the coronal plane MIP image can be used as an auxiliary.

The degenerate X-axis component Axᵢ of the object projection coordinates on the axial plane MIP image, the degenerate Z-axis component Szₖ of the object projection coordinates on the sagittal plane MIP image, and the components Cxᵢ and Czₖ of the object projection coordinates on the degenerate coronal plane MIP image on two coordinate axes (X axis and Z axis) may be expressed by the average values [symbol] , [symbol] , [symbol] , and [symbol] . Thus, formula (2) described above for calculating the global coordinates of the object in the global coordinate system of the imaging device can be changed to formula (4) as shown below:

$$[ ] = \frac{1}{2} ( [ \begin{matrix} \\ {Ay}_{j} \\ 0\end{matrix} ] + [ \begin{matrix}0 \\ {Sy}_{j} \\ \end{matrix} ] + [ \begin{matrix} \\ 0 \\ \end{matrix} ] ) \qquad ( 4 )$$

where [symbol] represents an estimated value, and [symbol] represents an average value. [symbol] represents a component of the global coordinates on the X axis, [symbol] represents a component of the global coordinates on the Y axis, [symbol] represents a component of the global coordinates on the Z axis, [symbol] represents a component of the projection coordinates related to an XY orthogonal plane feature projection image among the three orthogonal plane feature projection images on the X axis, Ayⱼ represents a component of the projection coordinates related to the XY orthogonal plane feature projection image among the three orthogonal plane feature projection images on the Y axis, Syⱼ represents a component of the projection coordinates related to a YZ orthogonal plane feature projection image among the three orthogonal plane feature projection images on the Y axis, [symbol] represents a component of the projection coordinates related to the YZ orthogonal plane feature projection image among the three orthogonal plane feature projection images on the Z axis, [symbol] represents a component of the projection coordinates related to an XZ orthogonal plane feature projection image among the three orthogonal plane feature projection images on the X axis, and [symbol] represents a component of the projection coordinates related to the XZ orthogonal plane feature projection image among the three orthogonal plane feature projection images on the Z axis.

The coordinate axis components Ayⱼ and Syⱼ of the remaining non-degenerate object projection coordinates may also be represented by means of the interpolation using the same number of points described above. Thus, formula (4) described above can be changed to formula (5) as shown below:

$$[ ] = \frac{1}{2} ( [ \begin{matrix} \\ {Ay}_{l} \\ 0\end{matrix} ] + [ \begin{matrix}0 \\ {Sy}_{l} \\ \end{matrix} ] + [ \begin{matrix} \\ 0 \\ \end{matrix} ] ) , l = 1 , 2 , 3 , … 100 \qquad ( 5 )$$

Although the method of the present invention has been described according to the above sequence, the execution of the method of the present invention should not be limited to the above sequence. Rather, some steps in the method of the present invention may be performed in a different sequence or at the same time, or in some embodiments, certain steps may not be performed. In addition, any step in the method of the present invention may be performed with a module, unit, circuit, or any other suitable means for performing these steps.

After the global coordinates of the object are obtained, image reconstruction can be performed on the basis of the global coordinates, such as by means of multi-oblique plane image reconstruction (MPR) as described above.

According to an embodiment of the present invention, an object detection system 900 may further be provided as shown in FIG. 9. The object detection system 900 may be configured to perform the various methods described above. The object detection system may be included in an imaging device, such as the imaging device in the imaging system 100 shown in FIG. 1 or the imaging system 200 shown in FIG. 2. The object detection system 900 may include a volatile or non-volatile memory or storage device 920 for storing volumetric image data generated by scanning a region of interest of a subject under examination by the imaging device. The volatile memory may include, for example, a random access memory (RAM) and the like, such as a static random access memory (SRAM) and a dynamic random access memory (DRAM). The non-volatile memory may include, for example, a hard disk, a floppy disk, an optical disk, flash memory, etc. The object detection system 900 may further include a processor 910 such as the image processor 110 and the image reconstructor 230 shown in FIGS. 1 and 2 to execute various commands. In addition, the object detection system 900 may further include a display 930, such as the display 232 shown in FIG. 2, for displaying various images, such as slice images, feature projection images, and reconstructed images as described herein.

According to an embodiment of the present invention, a computer-readable medium may further be provided. The computer-readable medium has instructions thereon, and when executed by a processor, the instructions cause the processor to perform the steps of the method of the present invention. Such a computer-readable medium may include, but is not limited to, a non-transitory tangible arrangement of an article manufactured or formed by a machine or device, including a storage medium, such as: a hard disk; any other types of disk, including a floppy disk, an optical disk, a compact disk read-only memory (CD-ROM), compact disk rewritable (CD-RW), and a magneto-optical disk; a semiconductor device such as a read-only memory (ROM), a random access memory (RAM) such as a dynamic random access memory (DRAM) and a static random access memory (SRAM), an erasable programmable read-only memory (EPROM), a flash memory, and an electrically erasable programmable read-only memory (EEPROM); a phase change memory (PCM); a magnetic or optical card; or any other type of medium suitable for storing electronic instructions. The computer-readable medium may be installed in an imaging device, or may be installed in a separate control device or computer that remotely controls the imaging device.

According to an embodiment of the present invention, an imaging device may further be provided. The imaging device includes the aforementioned object detection system of the present invention.

The technology described in the present invention may be implemented at least in part through hardware, software, firmware, or any combination thereof. For example, aspects of the technology may be implemented through one or more microprocessors, digital signal processors (DSP), application-specific integrated circuits (ASIC), field programmable gate arrays (FPGA), or any other equivalent integrated or separate logic circuits, and any combination of such parts embodied in a programmer (such as a doctor or patient programmer, stimulator, or the other apparatuses). The term “processor”, “processing circuit”, “controller” or “control module” may generally refer to any of the above noted logic circuits (either alone or in combination with other logic circuits), or any other equivalent circuits (either alone or in combination with other digital or analog circuits).

Multiple examples of the embodiments of the present invention will be provided below. The various details of the examples may be used in one or more embodiments of the present invention, and may be combined with one another to form unique embodiments.

Example 1 is an object detection method. At least a part of the object is located in a subject under examination. The object detection method includes: obtaining volumetric image data generated by scanning a region of interest of the subject by an imaging device; converting the volumetric image data into feature projection images, the feature projection images comprising three orthogonal plane feature projection images; detecting coordinates of the object in each of the three orthogonal plane feature projection images to obtain corresponding projection coordinates of the object in respective coordinate systems of the three orthogonal plane feature projection images; and obtaining global coordinates of the object in a global coordinate system of the imaging device on the basis of the projection coordinates of the object.

Example 2 includes the object detection method according to Example 1, wherein the object includes a rotating body having two-dimensional features.

Example 3 includes the object detection method according to Example 1, wherein the object includes an interventional object, a lesion, a bone, an organ tissue structure, and/or a vascular structure.

Example 4 includes the object detection method according to Example 1, wherein the object includes a needle, an endoscope, an implant, a catheter, a guide wire, a dilator, an ablator, and/or a contrast agent.

Example 5 includes the object detection method according to Example 1, wherein the feature projection images include one or more of the following items: a max intensity projection image, an average intensity projection image, a min intensity projection image, a standard deviation projection image, and a combination of two or more thereof.

Example 6 includes the object detection method according to Example 1, wherein the three orthogonal planes are an axial plane, a sagittal plane, and a coronal plane of the subject.

Example 7 includes the object detection method according to Example 1, wherein the obtaining global coordinates of the object includes: converting the projection coordinates into the global coordinates by means of the following formula:

$$[ ] = \frac{1}{2} ( [ \begin{matrix}{Ax}_{i} \\ {Ay}_{j} \\ 0\end{matrix} ] + [ \begin{matrix}0 \\ {Sy}_{j} \\ {Sz}_{k}\end{matrix} ] + [ \begin{matrix}{Cx}_{i} \\ 0 \\ {Cz}_{k}\end{matrix} ] ) ,$$

where [symbol] represents a component of the global coordinates on the X axis, [symbol] represents a component of the global coordinates on the Y axis, [symbol] represents a component of the global coordinates on the Z axis, Axᵢ represents a component of the projection coordinates related to an XY orthogonal plane feature projection image among the three orthogonal plane feature projection images on the X axis, Ayⱼ represents a component of the projection coordinates related to the XY orthogonal plane feature projection image among the three orthogonal plane feature projection images on the Y axis, Syⱼ represents a component of the projection coordinates related to a YZ orthogonal plane feature projection image among the three orthogonal plane feature projection images on the Y axis, Szₖ represents a component of the projection coordinates related to the YZ orthogonal plane feature projection image among the three orthogonal plane feature projection images on the Z axis, Cxᵢ represents a component of the projection coordinates related to an XZ orthogonal plane feature projection image among the three orthogonal plane feature projection images on the X axis, and Czₖ represents a component of the projection coordinates related to the XZ orthogonal plane feature projection image among the three orthogonal plane feature projection images on the Z axis.

Example 8 includes the method according to any one of Examples 1-7, wherein the obtaining global coordinates of the object includes: performing an interpolation operation using the same number of points on one or more projection coordinates among the projection coordinates of the object in the coordinate systems of the three orthogonal plane feature projection images.

Example 9 includes the object detection method according to Example 8, wherein the obtaining global coordinates of the object includes: performing an average operation on one or more projection coordinates among the projection coordinates subjected to the interpolation operation.

Example 10 includes the object detection method according to Example 1, wherein dot matrices of two images among the three orthogonal plane feature projection images are smaller than a dot matrix of the other image.

Example 11 includes the object detection method according to Example 1, wherein a dot matrix of one image among the three orthogonal plane feature projection images corresponds to the periphery of the object.

Example 12 includes the object detection method according to Example 1, further including: performing multi-oblique plane reconstruction on the basis of the global coordinates to display an overall appearance of the object and the region of interest in a reconstructed image.

Example 13 includes the object detection method according to Example 12, wherein the displaying includes displaying a trajectory of the object.

Example 14 is an object detection system. At least a part of the object is located in a subject under examination. The object detection system includes a memory, the memory being configured to obtain volumetric image data generated by scanning a region of interest of the subject by an imaging device. The object detection system further includes a processor configured to perform the following: obtaining the volumetric image data from the memory; converting the volumetric image data into feature projection images, the feature projection images comprising three orthogonal plane feature projection images; detecting coordinates of the object in each of the three orthogonal plane feature projection images to obtain corresponding projection coordinates of the object in respective coordinate systems of the three orthogonal plane feature projection images; and obtaining global coordinates of the object in a global coordinate system of the imaging device on the basis of the projection coordinates of the object. The object detection system further includes a display, configured to display a reconstructed image and feature projection images of the reconstructed image.

Example 15 includes the object detection system according to Example 14, wherein the object includes a rotating body having two-dimensional features.

Example 16 includes the object detection system according to Example 14, wherein the object includes an interventional object, a lesion, a bone, an organ tissue structure, and/or a vascular structure.

Example 17 includes the object detection system according to Example 14, wherein the object includes a needle, an endoscope, an implant, a catheter, a guide wire, a dilator, an ablator, and/or a contrast agent.

Example 18 includes the object detection system according to Example 14, wherein the feature projection images include one or more of the following items: a max intensity projection image, an average intensity projection image, a min intensity projection image, a standard deviation projection image, and a combination of two or more thereof.

Example 19 includes the object detection system according to Example 14, wherein the three orthogonal planes are an axial plane, a sagittal plane, and a coronal plane of the subject.

Example 20 includes the object detection system according to Example 14, wherein the obtaining global coordinates of the object includes: converting the projection coordinates into the global coordinates by means of the following formula:

$$[ ] = \frac{1}{2} ( [ \begin{matrix}{Ax}_{i} \\ {Ay}_{j} \\ 0\end{matrix} ] + [ \begin{matrix}0 \\ {Sy}_{j} \\ {Sz}_{k}\end{matrix} ] + [ \begin{matrix}{Cx}_{i} \\ 0 \\ {Cz}_{k}\end{matrix} ] ) ,$$

where [symbol] represents a component of the global coordinates on the X axis, [symbol] represents a component of the global coordinates on the Y axis, [symbol] represents a component of the global coordinates on the Z axis, Axᵢ represents a component of the projection coordinates related to an XY orthogonal plane feature projection image among the three orthogonal plane feature projection images on the X axis, Ayⱼ represents a component of the projection coordinates related to the XY orthogonal plane feature projection image among the three orthogonal plane feature projection images on the Y axis, Syⱼ represents a component of the projection coordinates related to a YZ orthogonal plane feature projection image among the three orthogonal plane feature projection images on the Y axis, Szₖ represents a component of the projection coordinates related to the YZ orthogonal plane feature projection image among the three orthogonal plane feature projection images on the Z axis, Cxᵢ represents a component of the projection coordinates related to an XZ orthogonal plane feature projection image among the three orthogonal plane feature projection images on the X axis, and Czₖ represents a component of the projection coordinates related to the XZ orthogonal plane feature projection image among the three orthogonal plane feature projection images on the Z axis.

Example 21 includes the system according to any one of Examples 14-20, wherein the obtaining global coordinates of the object includes: performing an interpolation operation using the same number of points on one or more projection coordinates among the projection coordinates of the object in the coordinate systems of the three orthogonal plane feature projection images.

Example 22 includes the object detection system according to Example 21, wherein the obtaining global coordinates of the object includes: performing an average operation on one or more projection coordinates among the projection coordinates subjected to the interpolation operation.

Example 23 includes the object detection system according to Example 14, wherein dot matrices of two images among the three orthogonal plane feature projection images are smaller than a dot matrix of the other image.

Example 24 includes the object detection system according to Example 14, wherein a dot matrix of one image among the three orthogonal plane feature projection images corresponds to the periphery of the object.

Example 25 includes the object detection system according to Example 14, further including: performing multi-oblique plane reconstruction on the basis of the global coordinates to display an overall appearance of the object and the region of interest in a reconstructed image.

Example 26 includes the object detection system according to Example 25, wherein the displaying includes displaying a trajectory of the object.

Some illustrative embodiments of the present invention have been described above. However, it should be understood that various modifications can be made to the exemplary embodiments described above without departing from the spirit and scope of the present invention. For example, an appropriate result can be achieved if the described techniques are performed in a different order and/or if the components of the described system, architecture, apparatus, or circuit are combined in other manners and/or replaced or supplemented with additional components or equivalents thereof; accordingly, the modified other embodiments also fall within the protection scope of the claims.

1. An object detection method, at least a part of the object being located in a subject under examination, the object detection method comprising:
obtaining volumetric image data generated by scanning a region of interest of the subject by an imaging device;
converting the volumetric image data into feature projection images, the feature projection images comprising three orthogonal plane feature projection images;
detecting coordinates of the object in each of the three orthogonal plane feature projection images to obtain corresponding projection coordinates of the object in respective coordinate systems of the three orthogonal plane feature projection images; and
obtaining global coordinates of the object in a global coordinate system of the imaging device on the basis of the projection coordinates of the object.

2. The object detection method according to claim 1, wherein the object comprises a rotating body having two-dimensional features.

3. The object detection method according to claim 1, wherein the object comprises a needle, an endoscope, an implant, a catheter, a guide wire, a dilator, an ablator, and/or a contrast agent.

4. The object detection method according to claim 1, wherein the feature projection images comprise one or more of the following items: a max intensity projection image, an average intensity projection image, a min intensity projection image, a standard deviation projection image, and a combination of two or more thereof.

5. The object detection method according to claim 1, wherein the three orthogonal planes are an axial plane, a sagittal plane, and a coronal plane of the subject.

6. The object detection method according to claim 1, wherein the obtaining global coordinates of the object comprises: performing an interpolation operation using the same number of points on one or more projection coordinates among the projection coordinates of the object in the coordinate systems of the three orthogonal plane feature projection images.

7. The object detection method according to claim 6, wherein the obtaining global coordinates of the object comprises: performing an average operation on one or more projection coordinates among the projection coordinates subjected to the interpolation operation.

8. The object detection method according to claim 1, further comprising: performing multi-oblique plane reconstruction on the basis of the global coordinates to display an overall appearance of the object and the region of interest in a reconstructed image.

9. The object detection method according to claim 8, wherein the displaying comprises displaying a trajectory of the object.

10. An object detection system, at least a part of the object being located in a subject under examination, the object detection system comprising:
a memory, configured to store volumetric image data generated by scanning a region of interest of the subject by an imaging device;
a processor, configured to perform the following:
obtaining the volumetric image data from the memory;
converting the volumetric image data into feature projection images, the feature projection images comprising three orthogonal plane feature projection images;
detecting coordinates of the object in each of the three orthogonal plane feature projection images to obtain corresponding projection coordinates of the object in respective coordinate systems of the three orthogonal plane feature projection images; and
obtaining global coordinates of the object in a global coordinate system of the imaging device on the basis of the projection coordinates of the object; and
a display, configured to display a reconstructed image and feature projection images of the reconstructed image.

11. The object detection system according to claim 10, wherein the object comprises a rotating body having two-dimensional features.

12. The object detection system according to claim 10, wherein the object comprises a needle, an endoscope, an implant, a catheter, a guide wire, a dilator, an ablator, and/or a contrast agent.

13. The object detection system according to claim 10, wherein the feature projection images comprise one or more of the following items: a max intensity projection image, an average intensity projection image, a min intensity projection image, a standard deviation projection image, and a combination of two or more thereof.

14. The object detection system according to claim 10, wherein the three orthogonal planes are an axial plane, a sagittal plane, and a coronal plane of the subject.

15. The system according to claim 10, wherein the obtaining global coordinates of the object comprises: performing an interpolation operation using the same number of points on one or more projection coordinates among the projection coordinates of the object in the coordinate systems of the three orthogonal plane feature projection images.

16. The object detection system according to claim 15, wherein the obtaining global coordinates of the object comprises: performing an average operation on one or more projection coordinates among the projection coordinates subjected to the interpolation operation.

17. The object detection system according to claim 10, further comprising: performing multi-oblique plane reconstruction on the basis of the global coordinates to display an overall appearance of the object and the region of interest in a reconstructed image.

18. The object detection system according to claim 17, wherein the displaying comprises displaying a trajectory of the object.
